(19) United States
(12) Patent Application Publication
(10) Pub. No.: US 2007/0086584 A1
(43) Pub. Date: Apr. 19, 2007

(54) VoIP-Based Call-Center System and Method for Managing Communications in a Computer Network

(76) Inventor: Pascal Rossini, Montreux (CH)

Correspondence Address: STURM & FIX LLP, 206 SIXTH AVENUE, SUITE 1213, DES MOINES, IA, 50309-4076, US

(21) Appl. No.: 11/539,718

(22) Filed: Oct. 9, 2006

Related U.S. Application Data
(63) Continuation-in-part of application No. 11/036,849, filed on Jan. 14, 2005.

(30) Foreign Application Priority Data
Mar. 19, 2004 (WO) PCT/IB04/00987
Dec. 20, 2005 (JP) 2005-365652

(51) Int. Cl. H04M 7/00

(52) U.S. Cl. 379/222

(57) ABSTRACT

A VoIP-based system and method for managing the placement of VoIP and other communications on the Internet wherein host sites have a zone linked to a sponsor site to enable a user to initiate a VoIP communication or another communication like video, telephone or e-mail with a sponsor by making a request. The sponsor site has an associated call center with a team of operators for handling the VoIP and other communications. The system comprises a communications management platform that constitutes a virtual call center. In response to a user request, the management platform checks if any operators on the call center having the language capability and competence to deal with the enquiries on the product(s) and/or service(s) specified in the request are available to make communications; transmits the request to an available/competent operator; sets up, when the operator initiates a VoIP or other communication, an electronic data entry form for the operator to record data about the communication during and/or after the communication; and provides a log of all user requests and resulting communications.

### RELATED APPLICATIONS

This application is a Continuation-in-Part of application Ser. No. 11/036,849 filed 14 Jan. 2005 and claiming priority from PCT patent application PCT/IB04/000987 filed 19 Mar. 2004, and Japanese Application No. 2005-365652 filed Dec. 20, 2005, which are incorporated by reference herein in their entirety.

### FIELD OF THE INVENTION

The invention relates to a VoIP-based system and method for managing communications via the Internet and other networks.

### BACKGROUND OF THE INVENTION

There have been many proposals for making communications over the Internet using the so-called VoIP, meaning Voice over Internet Protocol. VoIP is the routing of voice conversations over the Internet or through any other IP-based network. The term VoIP as used herein includes both voice (telephone) and video communications.

Using programs like SKYPE, MSN and GIZMO, pay-per-call enables an advertiser to enter into direct contact with a client without any communications expense, either for technical support, direct marketing or sales assistance. The so-called “click-to-call” service lets users click a button and immediately speak with a customer service representative, the call being carried over VoIP or the customers may request an immediate call back by entering their phone number.

However, the existing VoIP proposals for private or commercial use basically simply allow the parties to enter into a VoIP communication over the Internet, principally to meet the concern for having a no-cost or low-cost communication. This is unsatisfactory for commercial operations where there is a need to direct enquiries to telephone operators that are competent to deal with specific types of enquiries, particularly where the customer may request a communication in his preferred language, for example in large organizations employing many operators to answer enquiries where there is a need to keep track of the enquiries and follow-up.

On the other hand, commercial operations like sales forces and technical advice services use telephone call centers to deal with incoming requests from clients or potential clients. Generally speaking, the setting up of such call centers is difficult and costly, due to large capital expenditures and technical complexities. VoIP has so far not offered a solution to these problems.

### SUMMARY OF THE INVENTION

To meet these needs, the invention provides a VoIP-based system and method for managing the placement of VoIP and other communications (video, telephone and e-mail) via a distributed computer network such as the Internet wherein a plurality of host sites can access at least one sponsor site, each host site has a zone linked to the sponsor site enabling a user to initiate a VoIP or other communication like video, telephone or e-mail with the holder of a sponsor site (“the sponsor”) by making a request that specifies the language used, the user's VoIP ID, telephone number or e-mail address and one or more products or services of interest, and the sponsor site has an associated call center (like a telephone exchange) with a plurality of operators for handling the VoIP and other communications, each operator having given language capabilities and being classified as competent for dealing with enquiries on one or more products or services.

The system according to the invention (and the corresponding method) comprises at least one communications management platform that serves as a virtual call center and is arranged, in response to a user request made from the host site to initiate a VoIP or other communication with the sponsor, to perform the following operations (a), (b) and at least one of (c) and (d):
a) to check if any operators of the call center having the language capability and competence to deal with the enquiries on the product(s) and/or service(s) specified in the request are available to make communications,
b) to transmit the user's request to an operator on the call center having the language capability and competence to deal with the enquiries on the product(s) and/or service(s) specified in the request and who is available to make communications or has an upcoming availability to make communications,
c) to set up, when an operator initiates a VoIP, video or telephone communication with the user in response to a request, an electronic data entry form for the operator to record data about the communication during and/or after the communication, and
d) to log all user requests for a call to the sponsor, and all resulting VoIP or other communications initiated by the operators, to provide a set of data on said requests and communications.

The invention thus provides a virtual call center that can easily be set up with no additional hardware investments or software costs. This is possible because the inventive system can run on a company's existing infrastructure of computers with Internet access. All that is required is to have Skype or another VoIP application installed on the computer. This ease of set-up is a considerable jump from traditional call center solutions, which required hard- and software installations, consultants, complicated configurations and so on.

The specification of the language in the request is preferably by selection of one of a predetermined number of language options in the request or could alternatively be by the context of the language of the request.

The system and method of the invention find application when the sponsor site provides either the targeted contextual display of subjects, in particular advertising; distance learning; technical support services; advisory services; e-business; or telemarketing.

In particular, the system of the invention can be part of a greater system for the targeted contextual display of advertisements or other subjects in a distributed computer network such as the Internet which comprises a plurality of sponsor sites each containing subjects to be displayed on host sites and a plurality of host sites each having at least one page arranged to display subjects from sponsor sites, wherein the page of the host sites with a zone linked by VoIP contains a contextual subject such as an advertisement.

Such system for the targeted contextual display of subjects, in particular advertisements, can comprise a plurality of sponsor/host management platforms each having operating means that include:
a sponsor site management unit that is accessible to sponsors, that includes means for sponsors to administer the targeted display of subjects from sponsor sites, and means for storing keywords, categories and/or parameters that are derived from sponsor sites and that identify contexts for the targeted display of subjects in the host sites;
a host site management unit accessible to hosts, that includes means for hosts to administer the targeted display of subjects from sponsor sites on pages of their host sites, and means for storing keywords, categories and/or parameters that are derived from host sites and that identify contexts by which the host sites are targeted; and
means for matching the keywords, categories and/or parameters of the sponsor sites with those of the host sites for the targeted contextual display of subjects from sponsor sites on host sites.

To achieve this, the system comprises a shared server platform common to the different sponsor/host management platforms. The operating means of all of the management platforms are compatible. The means for matching of the sponsor/host management platforms are interconnected via the shared server platform, so it will be possible for the sponsor/host management platforms to operate independently, but in cooperation with one another via the shared server platform.

Each sponsor/host management platform can be associated with its own sponsor sites and its own host sites, which can access only their own sponsor/host management platform. Each sponsor/host management platform constitutes an autonomous platform for the targeted contextual display of subjects in the distributed computer network. Moreover, the shared server platform is arranged to enable the targeted contextual display of subjects from sponsor sites on host sites that are associated with different sponsor/host management platforms.

With this embodiment, each management server platform enables the independent and autonomous operation of targeted advertising links between the sponsors and hosts of the sponsor/host management platform, and the shared server platform allows sharing between the sponsors and hosts of different sponsor/host management platforms, as set out in detail below. This allows the operator of each sponsor/host management platform to independently manage its own network of sponsor sites and host sites using its own brand or trade designation. This is not possible with existing sponsored link systems that have a purely central and closed management, or with existing arrangements for local advertising.

To enable such sharing, each sponsor/host management platform can be identified by its own management site code, and this unique code of each sponsor/host management platform is associated with all its activities as follows.

This code associates the keywords, categories and/or parameters of each management platform's sponsor sites and of each management platform's host sites with the management platform code of the sponsor/host management platform with which they are associated. In this way all sponsor sites and host sites are linked by this code to the sponsor/host management platform so that all operations pertaining to a sponsor site or a host site can be identified by the code of their management platform.

Following this scheme, the keywords, categories and/or parameters of sponsor sites, which are associated with the management platform code of one sponsor/host management platform, are available for matching with the keywords, categories and/or parameters of the host sites. This matching is via the management platform itself for matching sponsor and host sites of the same management platform, or via the shared server platform for matching with those of other management platforms, this availability for matching being subject to possible exceptions. In other words, all sponsor sites of one sponsor/host management platform can be published on matching host sites of the same management platform, or via the shared server platform with those of different management platforms. The possible exceptions can be defined by the sponsors (for instance a sponsor who does not want his advertisements placed on the pages of indicated competitors) or by the proprietor of the management platform.

Likewise, the keywords, categories and/or parameters of host sites, which are associated with the management platform code of one sponsor/host management platform, are available for matching with the keywords, categories and/or parameters of the sponsor sites of the same management platform or via the shared server platform with those of other management platforms, this availability for matching also being subject to possible exceptions. This means that all host sites of one sponsor/host management platform can receive matching advertisements from the sponsor sites of the same management platform, or via the shared server platform with those of different sponsor/host management platforms, with possible exceptions defined by the hosts (for instance a host who does not want advertisements of its indicated competitors to be published on his own site) or exceptions defined by the operator of the sponsor/host management platform.

This represents one way by which the system enables the targeted contextual display of subjects from sponsor sites on host sites that are associated with the same sponsor/host management platform or that are associated with different management platforms, while the management of the individual management platforms remains autonomous. This allows the management platform's operator to independently manage the business aspects of targeted advertising links in a coordinated fashion where their hosts have access to a wide range of advertisers and where their advertisers can target a wide range of hosts.

The system preferably comprises means for compiling statistics relating to the operations performed relating to given sponsor sites and to given host sites, these statistics preferably being associated with the management platform codes of the sponsor sites and host sites. In one embodiment, each sponsor/host management platform comprises means for compiling such statistics.

The shared server platform of the system can comprise a central statistical unit that is common to the sponsor/host management platforms, the central statistical unit having means for compiling statistics relating to operations performed by the different management platforms relating to given sponsor sites and operations performed by the different management platforms relating to given host sites. The shared server platform may also make use of statistics generated in the different sponsor/host management platform.

These compiling means in the sponsor/host management platforms and/or in the shared server platform for instance compile statistics that relate to the number of times that given sponsor sites communicate with or are displayed or accessed by host sites, the duration of such communication, display or access and/or the number of times that an action is performed in relation thereto, and to the number of times that given host sites communicate with or display or access sponsor sites, the duration of such communication, display or access and/or the number of times that an action is performed in relation thereto.

When the shared server platform performs statistical operations, corresponding results will be made available to the sponsor/host management platforms so their operators can access relevant statistics, and so that the sponsors and hosts concerned by particular statistics can access them.

Preferably, each sponsor/host management platform comprises means for deriving the keywords, categories and/or parameters from sponsor sites and host sites. The keyword/category/parameter deriving means can include at least one of the following, and preferably offers a large choice from the various possibilities:
a) means for assisting the input of keywords by the user of a sponsor site or a host site, for instance in the form of an assistance menu with prompts for the sponsor or host to input keywords;
b) means for automatically generating keywords, categories and/or parameters by analysis of text in a site, in particular allowing contextual analysis in real time;
c) means for generating keywords, categories and/or parameters from metatags in the header/title of a site.
d) means for processing audio content of a site and for generating keywords, categories and/or parameters from the processed audio content, which can include voice recognition programs that produce text from the audio content, this text then being analyzed for instance by the above-indicated means b).

A combination of the above means enables in particular real time matching of sponsor sites and host sites, by providing dynamic contextual matching of hosts and sponsors.

The system can operate with host sites whose display panel, in addition to having a zone linked by VOIP enabling the user to initiate a telephone communication with a sponsor, comprises one or more of the following:
i) a horizontal or vertical banner or other fixed space;
ii) a sidebar;
iii) linked text that activates a display in response to a user actuation;
iv) a superimposed movable element that can be displaced on a page of the host site and that contains links that activate a display in response to a user actuation (as in WO 2004/06156);
v) a panel common to several pages of a host site;
vi) display area(s) structured to display at least one of the following types of links: sponsored link; link towards a page on another site; link towards another page on the host site;
vii) a display panel made up of a function control area having a rectangular form, and rectangular display areas that can be opened in the corners and/or along edges of the control area; and
viii) display area(s) including images and/or text associated with sponsored links.

In an advantageous embodiment, the sponsor/host management platforms comprise means for storing, in the management platforms, the codes that define the attributes of the display panel of the host sites, these storing means in the management platform being accessible from the respective host sites, as described and claimed in WO 2004/061546. This combines the flexibility for user site integration according to WO 2004/061546 with the overall management flexibility of the present disclosure, making available to advertising agencies or other companies or individuals the possibility to operate an autonomous management platform having a local or field-restricted activity in the recruitment of advertisers and/or host sites. This possibility for increased flexibility in management of the host sites will usually be offered in conjunction with the other ways of managing host site pages, so that hosts have a wide choice of the ways displays can be made on their sites, using banners etc. whose parameters can also be defined in the code of the host site.

Additionally, at least one sponsor/host management platform of the system can maintain a site containing pages that are available as sponsor site/pages for use by advertisers who don't have their own site or who don't wish to use their own site for this purpose.

The system also allows advertisers to make a bid, that is to say “to buy” by auction bids, the right to appear in a predominant position on a site or on a site that is visited very frequently. Furthermore, it allows the administration of accounts associated with the users of this invention.

### BRIEF DESCRIPTION OF THE DRAWINGS

The invention will be further described with reference to the accompanying schematic drawings given by way of example, in which:

FIG. 1 is a diagram of a system for the targeted contextual display of advertisements illustrating how two sponsor/host management platforms interconnected via a shared server platform place advertisements on each others host sites;

FIG. 2 is a diagram of the organization of one sponsor/host management platform;

FIGS. 3, 4 and 5 are diagrams of steps in processing targeted advertising links;

FIG. 6 illustrates the principle of matching and scoring;

FIG. 7 is a diagram of another sponsor/host management platform and its interaction with a computer network;

FIG. 8a shows a browsing device applicable in the present invention, as it would appear on the computer display of a host site;

FIG. 8b shows the browsing device of FIG. 8a when it is partially closed; and

FIG. 9 is a diagram of a VoIP-based application according to the present invention.

### DETAILED DESCRIPTION

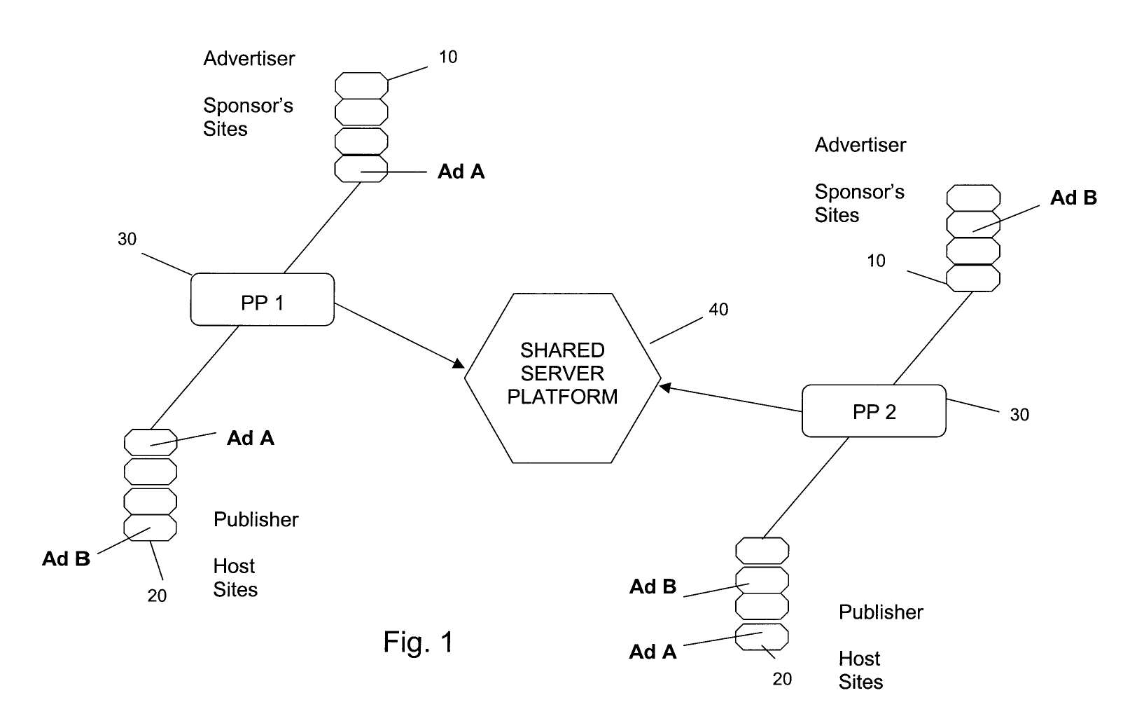

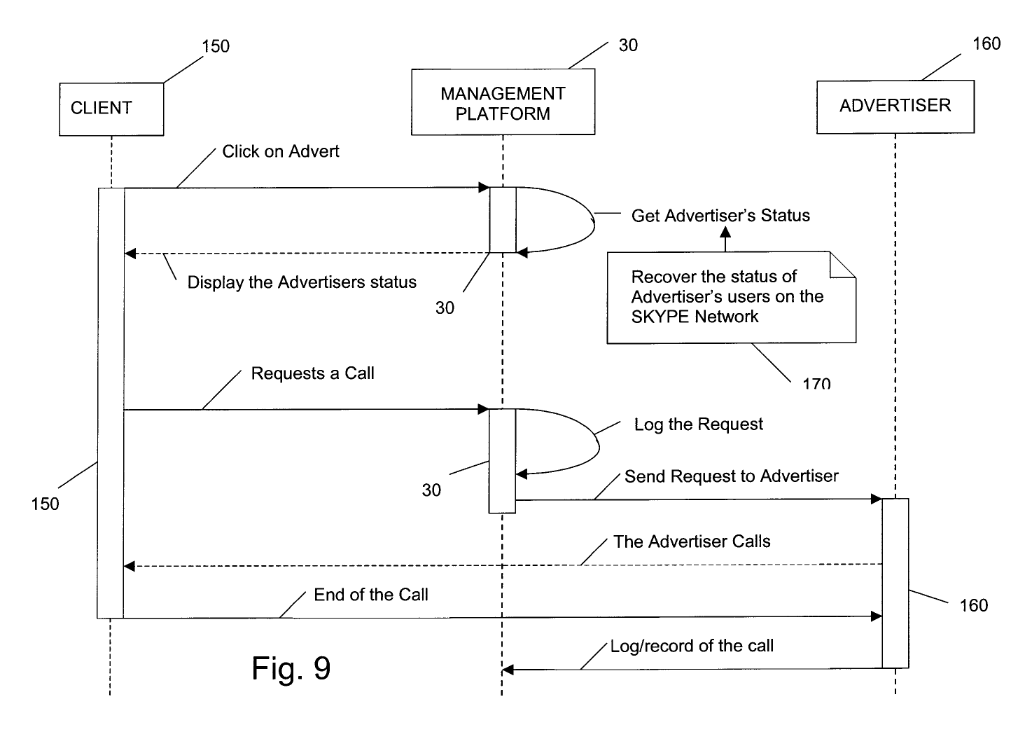

FIGS. 1 to 8 show systems, principally for the targeted contextual display of advertisements and generally Internet applications, to which the inventive system for the placement of VoIP and other communications of FIG. 9 can for example be applied.

Contextual Display of Subjects, in Particular Advertisements

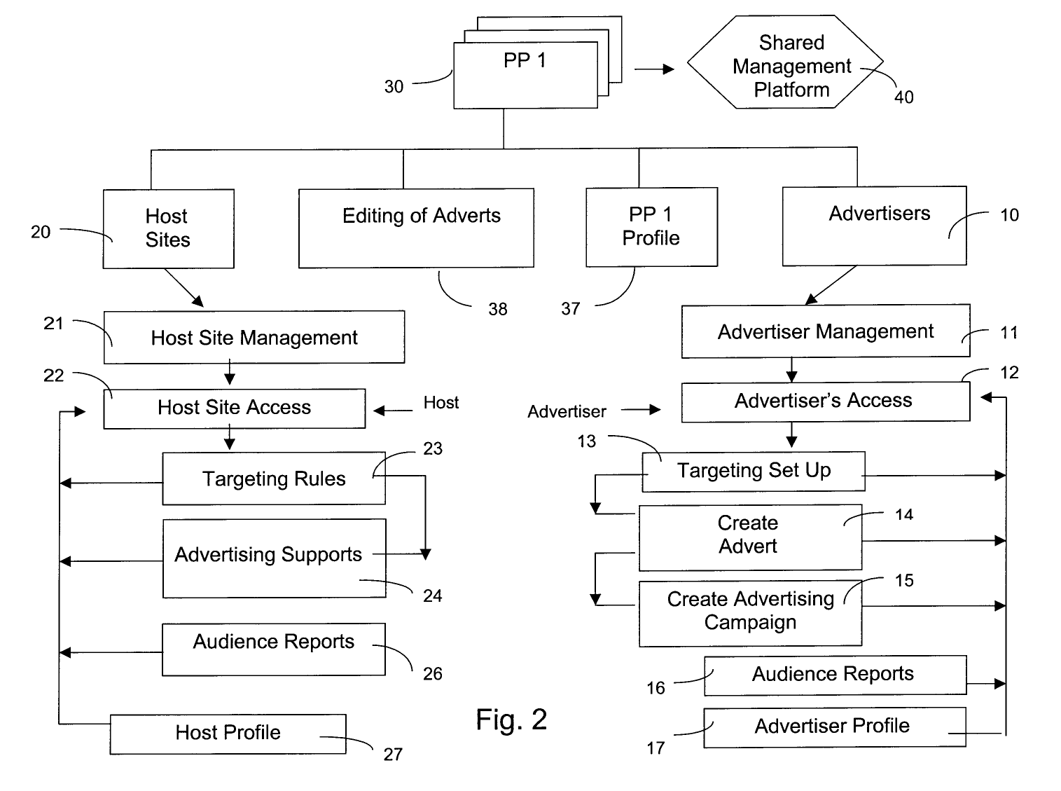

FIG. 1 schematically shows a system for the targeted contextual display of advertisements in a distributed computer network such as the Internet. The network comprises sponsor sites 10 each containing subjects to be displayed on host sites, and host sites 20 each having at least one page arranged to display advertisements or other subjects from sponsor sites 10. The system comprises several sponsor/host management platforms 30 each having operating means that will be described later in connection with FIGS. 2-6. These management platforms operate autonomously and are referred to as “Preferred Partners” or “PP” because their operators can each independently and autonomously manage all matters relating to the targeted display of advertisements from their sponsor's sites 10 and all matters relating to their associated host sites 20.

The system operates by comparing keywords, categories and/or parameters that are derived from sponsor sites 10 and that identify contexts for the targeted display of subjects in the host sites 20 with keywords, categories and/or parameters that are derived from host sites 20 and that identify contexts by which the host sites 20 are targeted.

The system has a shared server platform 40 for the different sponsor/host management platforms 30. The operating means of all of these management platforms 30 are identical or compatible and are interconnected via the shared server platform 40, so it will be possible for them to operate independently, but in cooperation with one another via the shared server platform 40.

For simplicity, FIG. 1 shows two sponsor/host management platforms 30, designated PP1 and PP2, associated with the shared server platform 40. Of course, any number of management platforms 30 can be operated from one shared server platform 40.

Each management platform 30 (PP1 and PP2) is associated with its own sponsor sites 10 and its own host sites 20 and constitutes an autonomous system for the targeted contextual display of subjects in the distributed computer network. Moreover, the shared server platform 40 is arranged to enable the targeted contextual display of advertisements or other subjects from sponsor sites 10 on host sites 20 that are associated with different management sites (PP1 or PP2). This allows the operator of each management site PP1 or PP2 to independently manage its own network of sponsor sites 10 and host sites 20. With this system the shared server platform 40 enables the independent and autonomous operation of targeted advertising links between the sponsors 10 and hosts 20 of each management platform PP1, PP2, etc. yet allows sharing between the sponsors and hosts of different management sites, as set out in detail below.

To enable such sharing, each management platform 30 (PP1 or PP2) can be identified by its own management platform code that is different for the different management platforms, and this unique code of each management platform is associated with all its activities as follows.

The keywords, categories and/or parameters of each management platform's sponsor sites 10 and the keywords, categories and/or parameters of each management platform's host sites 20 are associated with the management platform code of the management platform 30 (PP1 or PP2, etc) to which they belong. In this way all sponsor sites 10 and host sites 20 are linked by the management platform code to the management platform PP1 or PP2 to which they belong.

The keywords, categories and/or parameters of sponsor sites 10, which are associated with the management platform code of one management platform, say PP1, are available for matching with the keywords, categories and/or parameters of the host sites 20, via the management platform PP1 with those of the same management platform, or via the shared server platform 40 with those of the other management platform PP2, this availability being subject to possible exceptions. This means that all sponsor sites 10 of one management platform, say PP1, can be published on the host sites 20 of the same management platform PP1, or via the shared server platform 40 with those of different management platforms PP2 etc, with possible exceptions that, as mentioned above, can be defined by the sponsors (for instance a sponsor who does not want his advertisements placed on the pages of indicated competitors) or by the management platform's operator.

Likewise, the keywords, categories and/or parameters of host sites 20, which are associated with the management platform code of one management platform, say PP1, are available for matching with the keywords, categories and/or parameters of the sponsor sites 10 of the same management platform PP1 or via the shared server platform 40 with those of other management platform PP2 etc, this availability also being subject to possible exceptions. This means that all host sites 20 of one management platform can receive advertisements from the sponsor sites 10 of the same management platform PP1, or via the shared server platform 40 with those of different management platforms PP2 etc., with possible exceptions. As previously mentioned the exceptions can be defined by the hosts (for instance a host who does not want advertisements of its indicated competitors to be published on his own site) or by the management platform's operator.

This is illustrated in FIG. 1 by a simple example of an Advertisement A (Ad A) offered by one sponsor site 10 of management platform PP 1, and an Advertisement B (Ad B) offered by one sponsor site 10 of management platform PP 2. The derived contextual keywords of these adverts are compared, as described later, with the contextual keywords associated with the various host sites 20, and the advert is displayed on host sites 20 that show a corresponding match of keywords. In this example, one of the host sites of management platform PP1 shows a match with Ad A and displays this Ad A. Likewise, one of the host sites of management platform PP2 shows a match with Ad A and displays this Ad A. Similarly, another of the host sites of management platform PP2 shows a match with Ad B and displays this Ad B, and another of the host sites of management platform PP1 shows a match with Ad B and displays this Ad B.

The described system thus enables the targeted contextual display of subjects from sponsor sites 10 on host sites 20 that are associated with the same management platform (PP1/PP1 or PP2/PP2) or that are associated with different management platforms (PP1/PP2 or PP2/PP1), while the management of the targeted advertising links by the individual management platforms 30 remains autonomous. This allows management platform operators to independently manage the business aspects of targeted advertising links in a coordinated fashion where their hosts 20 have access to a wide range of advertisers 10 and where their advertisers can target a wide range of hosts.

The basic overall layout of a management platform 30's control interface is shown in FIG. 2. Each management platform 30 has software for managing, on one side advertisers 10 and on the other side host sites 20. Each management platform 30 also has its own profile unit 37 containing its coordinates, including a management platform code, and a module 38 for performing editing of adverts submitted by advertisers 10, and any other needed central functions. As indicated schematically, all management platforms 30 (PP1 etc) are coordinated via a central shared server platform 40.

In the described system, all of the means for displaying linked advertisements and for managing one set of advertisers 10 and one set of hosts 20 are bought together on a single management platform 30 under control of one operator. Several autonomous management platforms PP1, PP2 etc, each associated with different sets of advertisers 10 and hosts 20, are interconnected by a shared server platform 40.

As illustrated in FIG. 2, the management of advertisers 10 and hosts 20 on each management platform 30 is functionally separated into a separate advertiser management units 11 accessible to advertisers at 12 and a separate host site management unit 21 accessible to hosts at 22.

The advertiser management unit 11 is organized as follows. A secure access point for advertisers is provided at 12. This gives access to each advertiser for the necessary setting up, modification of and management of the advertiser's account. Thus the advertiser can participate in setting up the targeting of his adverts, at 13, creating (or inserting) an advert at 14 and creating an advertising campaign at 15. The advertiser management unit 11 also has a module 16 for audience reports, and a module 17 for the advertisers profile, containing his coordinates etc.

Targeting 13 of the adverts can for instance involve the steps of designating the name of the advert, selection of countries, selection of keywords and key phrases and selection of other criteria.

Creating an advert at 14 can for instance involve the steps of designating the name, editing the advert using usual resources, selection of the targeting rules, and limitation options.

Creating an advertising campaign at 15 can involve designating the name, setting the campaign attributes including duration and budget, various other advanced settings, selection of adverts, and budget per advert. This can be followed by an interface for publication of the campaign and a payment interface.

The audience reports 16 can be organized by advertising campaign, by advert and by other parameters such as territory.

On the host side, a secure access point for hosts is provided at 22. This gives access to each host for the necessary setting up, modification of and management of the host's account. Thus the host can participate in setting up the targeting rules pertaining to his site, at 23, and the setting up of advertising supports at 24. The latter involves introducing the necessary code to define zones on host pages to receive the targeted advertisements etc. The host management unit 11 also has a module 26 for audience reports, and a module 27 for the host's profile, containing his coordinates etc.

The targeting rules 23 can for instance involve the steps of designating the name of the host site, defining the formats for adverts for the search, defining the criteria, defining forbidden keywords, defining forbidden URLs, etc.

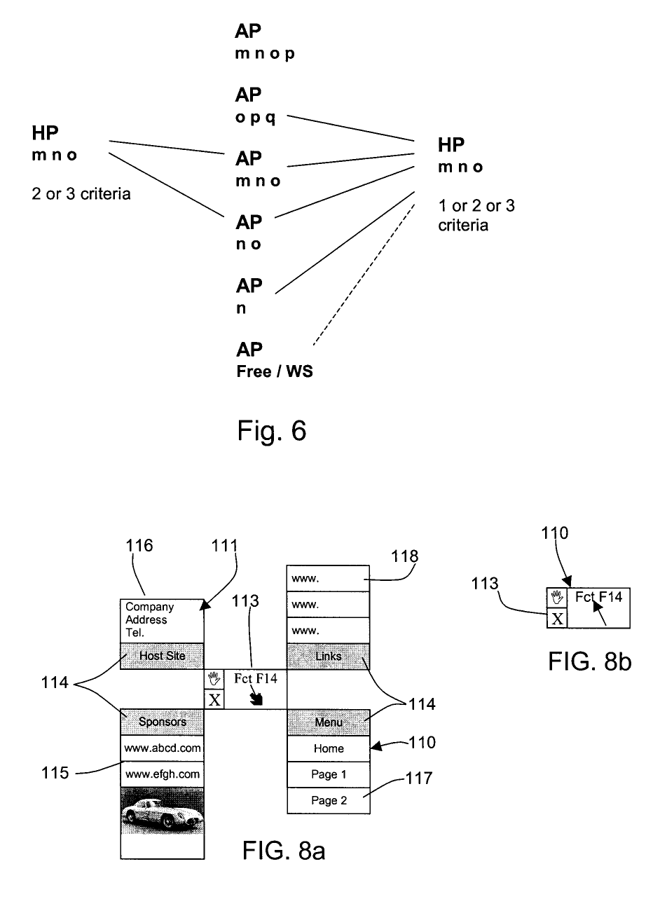

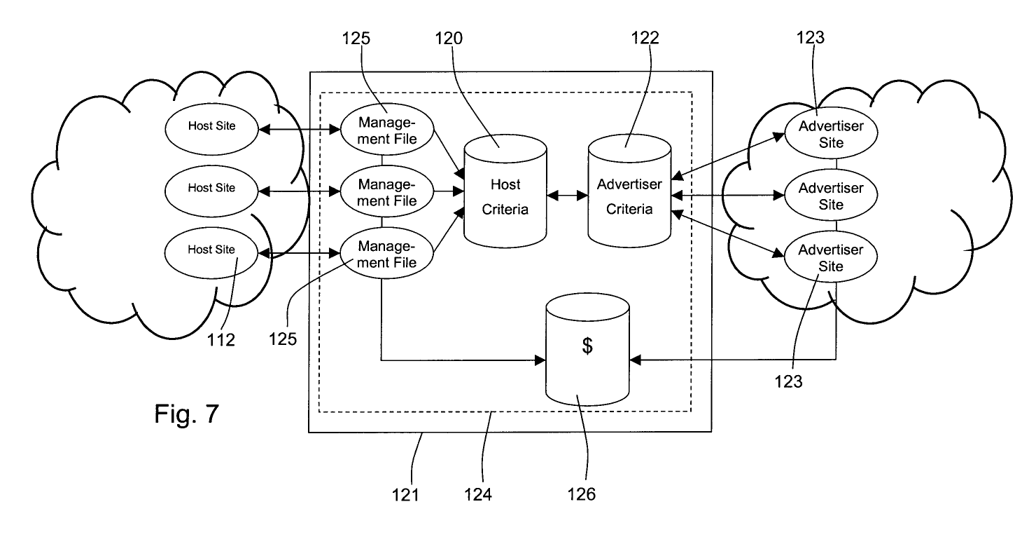

The setting up of advertising supports at 24 can involve designation of the name, selection of the targeting rules, creation of colors for the display from a palette, creation of the advertising link support (from banners, FeedSpiders using DMTL to provide a floating support—for details, see later under the description of FIG. 8a and FIG., 8b), advanced options, pre-visualization to test the appearance of the display, and code generation.

The module 26 for audience reports can be organized into reports by host sites.

The management platform 30 serves as an advertisement engine permitting the diffusion of sponsored contextual links or adverts on different host sites. The advertisement engine responds to different criteria from the websurfer, the advertiser and the host site, then sends the most relevant adverts. To generate results, the advertisement engine takes into account the following criteria: IP localization (of the websurfer, and of the host site, and possibly the sponsor site), languages; and keywords and other parameters and criteria.

As explained in greater detail below, the automated contextual display integrated into the management platform 30 is managed using different technologies such as the automatic analysis of web pages to reveal a theme by the automatic association of words using segmentation criteria or criteria related to the quality and content of the host site (articles, themes, positioning of elements), or by voice or sound analysis via voice recognition and processing in order to automatically determine relevant words or phrases. The display is done by adapting the supports (Internet, TV, Telephone) qualified as a function of the diffusion means.

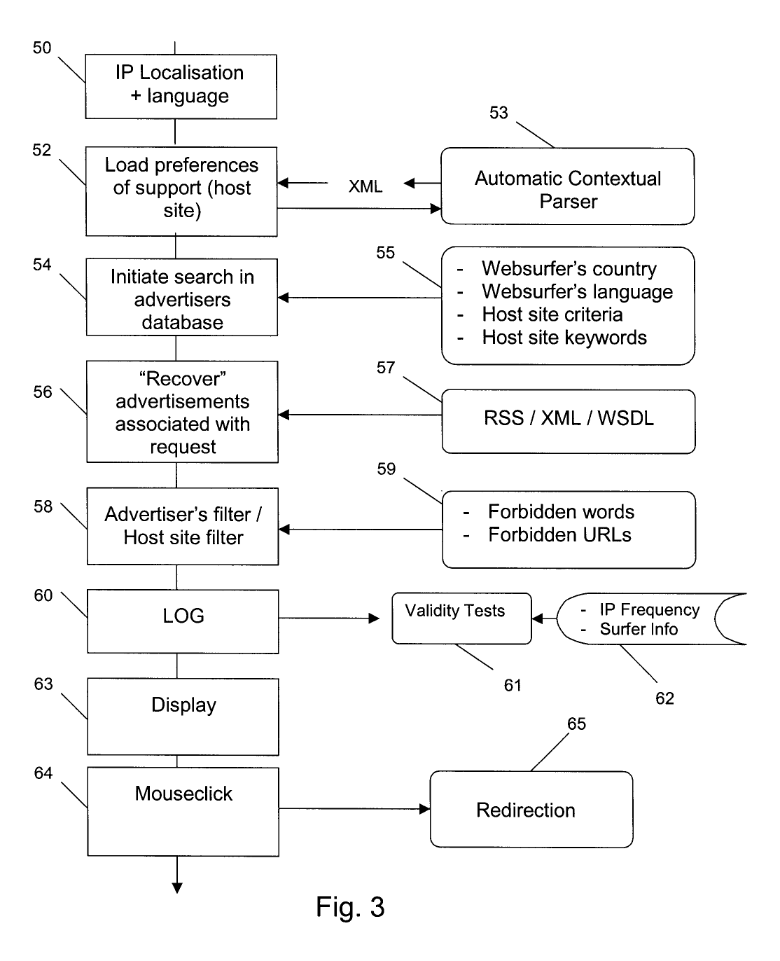

FIG. 3 shows several steps in the automated processing of targeted advertising links when a websurfer (user) accesses a host site 20. IP localization of the websurfer's computer and the websurfer's language are first identified, using standard routines, at 50. At 52 the system loads the host site's preferences in XML using an automatic contextual parser 53. These preferences can include preferences set by the host (in Targeting Rules 23) or determined contextually, as explained below. A search is then initiated at 54 in the advertiser's database; for this use is made of a processing unit 55 that contains the websurfer's country, the websurfer's language, and that uses host site criteria and host site keywords, set up as mentioned before. A comparison is made of the advertisements and host sites that have corresponding criteria, and relevant adverts are recovered at 56, and extracted from an advert database 57 containing a set of adverts in standard Internet formats like RSS (Rich Site Summary), XML (Extensible Markup Language), WSDL (Web Service Definition Language), etc. The selected adverts are then filtered at 58, through an advertiser's filter and a host site filter using, for this, pre-stored forbidden words and forbidden URL's 59 predefined by the advertiser of each of the selected adverts or by the host in question. A Log operation 60 is provided on the basis of validity tests 61 based for example on criteria 62 such as the IP frequency and websurfer information. This enables daily checking of all databases and reports in order to eliminate fraudulent clicking patterns. This can lead to the IP addresses of the identified users being blocked for a period of, say, 1 month or permanently.

Selected adverts are then displayed in step 63 on the host site as viewed on the websurfer's computer screen. When the websurfer executes a mouseclick 64 on the displayed advert, this redirects the websurfer's computer screen at 65 to show the advertiser's site.

The extraction of relevant adverts is further illustrated in FIG. 4. This Figure is an overview of the advert extraction process steps initiated by a websurfer or user 70 accessing a host site 73. This begins with a recovery of search options 71 based on the user's country and language 72, and a recovery of search options 74 based on the host site criteria and keywords 75. This is followed by a search 76 for matching adverts, made by iteration of adverts stored at 78 in RSS, XML or WDSL format. A matching and scoring 79 takes place leading to the extraction of relevant adverts 80 from the store 78.

The automatic search for keywords in a page is based primarily on four considerations:
1. Parsing of the title for metatags that gives a first weighting to words and attributes points, as in the following example of parsing a title for the word “opinion”:
   <title>DialogCentral—Opinion</title>
   <meta name=“description” content=“Identify and diagnose user experience issues and track user satisfaction page-by-page by continuously collecting and analyzing Web user feedback using OpinionLab OnlineOpinion system.38 >
   <meta name=“keywords” content=“Opinion Lab, OpinionLab, online opinion, onlineopinion, user feedback, website feedback,”>
2. Elimination of the menus and other “noise” factors, like images and ancillary text, from the page. This results in “cleaning” the page to leave only a principal text zone that is identified and, for example, outlined in a color like red.
3. Automatic detection of the situation of the texts to be analyzed in the principal text zones of the pages (at the center, in the right implies greater importance).
4. Association of selected keywords to synonyms and eponyms in order to reinforce the pertinence.
5. Stemming, as outlined below.

The concept of stemming used involves deciding which documents in a collection should be retrieved based on a query or profile that contains one or more search terms, plus perhaps additional information such as importance weights. The retrieval decision is made by comparing the terms of the query with important words or phrases (“index terms”) appearing in the document. The decision may be binary (retrieve/reject), or it may indicate the degree of relevance of the document to the query. Because words often have many morphological variants, recognizing pairs of terms such as “computing” and “computation” as equivalent requires some form of natural language processing (NLP). Often, morphological variants of words have similar semantic interpretations and can be considered as equivalent for the purpose of IR applications. For this purpose, stemming Algorithms, or stemmers, have been developed to reduce a word to its stem or root form in which the key terms of a query or document are represented by stems rather than by the original words. This means that different variants of a term can be conflated to a single representative form and also reduces the dictionary size, that is, the number of distinct terms needed to represent a set of documents. A smaller dictionary results in saving storage space and processing time. For information retrieval purposes, the stems generated may or may not be genuine words. For example, “computation” might be stemmed to “comput”—provided that different words with the same ‘base meaning’ are conflated to the same form, and words with distinct meanings are kept separate. An algorithm that converts a word to its linguistically correct root (“compute” in this case) is called a lemmatizer. Examples of products using stemming algorithms are the Lycos and Google search engines, and also thesauruses and other products using NLP for information retrieval.

FIG. 5 illustrates the steps in developing keywords and phrases from a web page. This operation begins by page recovery 90, followed by cleaning of the page and correction of the HTML code, at 91. A language detection operation and first parsing operation takes place at 92, involving loading of the required dictionaries 93. This is followed by a second parsing operation 94 according to frequency rules, and the creation of an expression tree (n word) 95. Next step 96 involves the application of HTML rules and analysis of metatag HTML expressions in the page header. A graphic placement step 98 is based on the placement of phrases 99. Stemming 100 involves searching 101 for words with the same root. Then there is a search for synonyms 102/103 and eponyms 103/104 which covers related words. Scoring takes place from the 2^{nd} parsing step 94 to the eponym step 103, whereby the analyzed words are weighted for value. Resulting from the analysis are selected keywords and phrases relevant to the content of the web page.

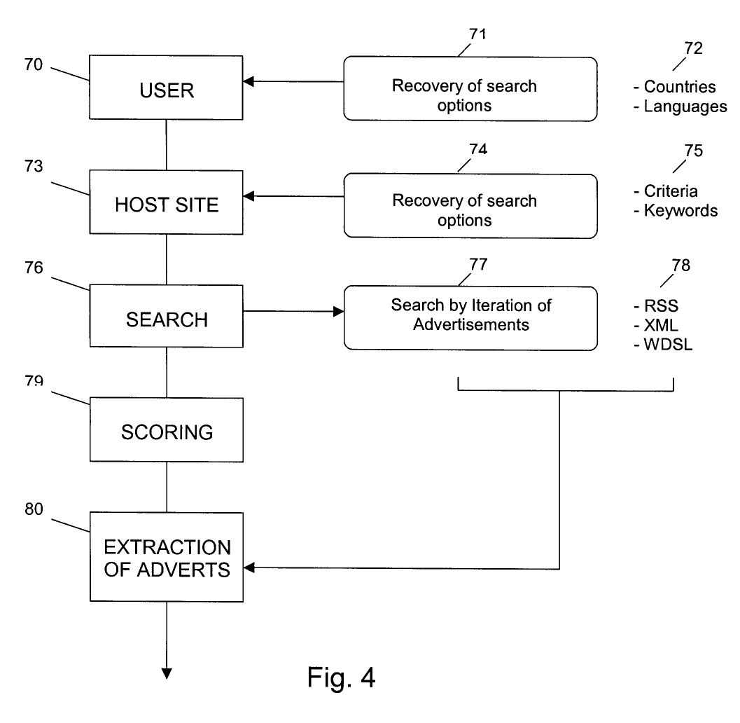

FIG. 6 illustrates a simulation of an example of matching associated with scoring. The middle column represents a series of Advertising Partners AP displaying different selection criteria for their adverts, these criteria being represented by the small letters “m”, “n”, o”, “p”, “q” in different combinations. The lowermost AP is a Web Service (such as that provided by Amazon) that offers free advertisements. Two Host Partners HP are represented, each having the same three criteria “m”, “n”, “o” for their adverts. However, the left hand HP specifies that 2 or 3 of its criteria must be fulfilled, whereas the right-hand HP specifies that 1, 2 or 3 of its criteria can be fulfilled.

In this example, the left-hand HP matches with two APs having the common criteria “mno” and “no”. The right-hand HP matches with four APs containing one or more of its three criteria. It can also match with the Free/WS AP. The latter would usually come into use to display an advert only if there are no correspondences with paying APs.

Note that with this matching scheme an advert (like “AP-mnop”—4 criteria) that has more criteria than the HP considered (both with 3 criteria) will never be displayed by this HP. The HP displays solely those adverts that correspond at most to the same number of criteria of the HP.

Note also that each HP can specify a maximum number of adverts, so that if a HP matches with a greater number of APs, it can operate with a random selection mode.

This simple example of FIG. 6 illustrates that having more criteria, and requiring the fulfillment of more criteria, makes the matching more selective.

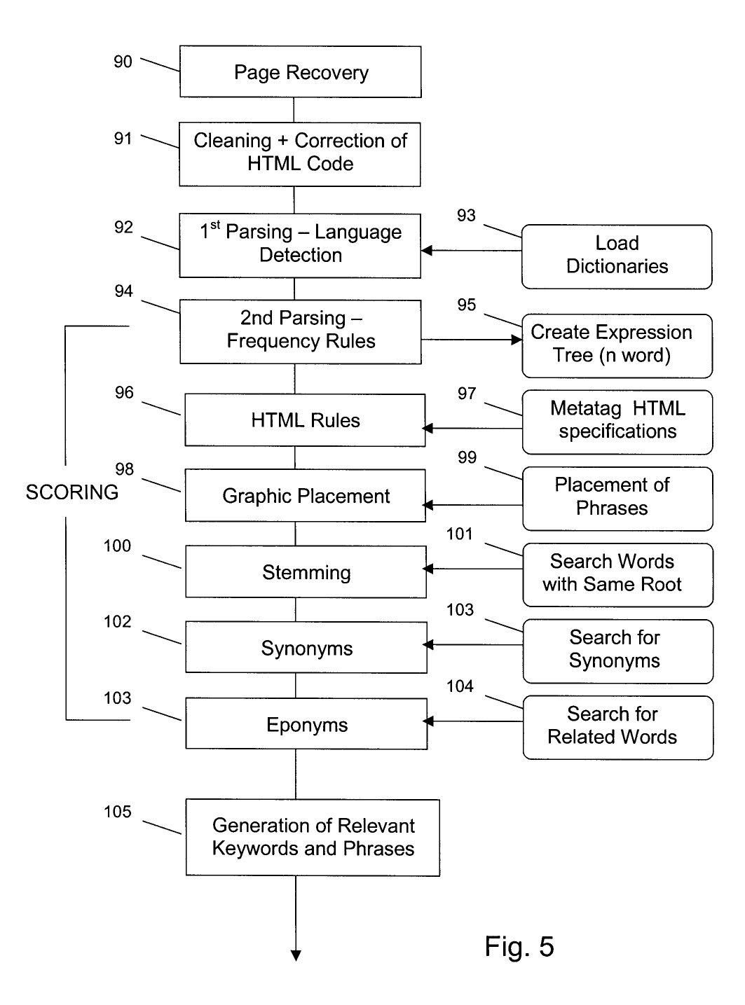

FIG. 7 illustrates a sponsor/host management platform comprising:
at least one management site 121 responsible for accounting and the diffusion of advertisements; this site allows the control of host sites 112 and of the advertisers' sites 123;
management files 125 inside the management site allowing users to construct a display panel 111 and define target criteria;
advertiser sites 123 allowing owners to make advertisements and diffuse them on the targeted display panels of the host sites;
a final user site called host site 112 where the host defines choice criteria and downloads the display panel. Then it is installed on the Internet navigator and delivers advertisements originating from advertisers sites.

The sponsor/host management platform allows also the control the display of links and payments, as well as invoicing.

A browser 110 (FIG. 8a) used in the host site of this embodiment is not configured, as in the equivalent devices of the prior art, by a computer code integrated into the code of the host site. On the contrary, the configuration of the browser is carried out in a specific file, called a management file 125, managed by a management site and containing the data necessary for the display of the links and the layout of the device.

The computer code of the host site 112 only contains one link that indicates the location of the management file 125. The latter contains the data necessary for the configuration of the browser 110. This file can be accessed by the owner of the host site 112, and modified at his convenience, without the owner of the management site having to intercede. Thus, different configurations can be tested very easily thus allowing greater flexibility for the user.

With reference to FIGS. 8a and 8b, the illustrated browser 110 notably includes a display panel 111 that can be made visible from a host site 112, on a computer display. According to this embodiment of the invention, the device is provided to allow the display of this panel according to several predefined formats and in particular according to the eight formats described below. The first format is conventional and is known as a banner. It refers to a horizontal band generally placed at the top of a page of a site.

The second format also corresponds to a band, which is vertical and generally placed on the left or the right of the page. These bands have dimensions that, without being normalized, are relatively standard so that the site creators can provide a (corresponding) reserved area during the design of an Internet site.

The third format is a vertical band, placed on the left of the page, in a zone usually reserved for the display of general data such as the history of the last sites visited or the user's favorite sites. This zone is known under the term “side bar”.

The fourth format is called a toolbar, which is a horizontal band that is displayed at the top of the screen, near the menu bar. According to one variant, the display panel can be displayed in the form of a tool bar in electronic messages.

The fifth format is a smartlink format wherein a relevant word or words in a webpage is selected automatically or manually, such that when the websurfer's screen pointer passes over the word by displacement of the websurfer's mouse, it actuates the display of adverts that are related to the underlined word(s).

The sixth format, called FeedSpider, is discussed in detail below with reference to FIGS. 8a and 8b; it can include the display of advertisements and streams of contextual news imported from freely-available sources of information worldwide.

The seventh format is called “Pay per call over VoiceIP”. This format enables the websurfer to place a toll-free call via the VOIP network from a personal computer to the advertiser. The advertiser pays only if the call reaches him. Further details of this system according to the invention are given in connection with FIG. 9.

The eighth format is in the form of pages maintained on the platform by the platform operator and that are available as sponsor site/pages for use by advertisers who don't have their own site or who don't wish to use their own site for this purpose.

These formats are proposed in such a way that the browsing device is compatible with the existing sites designed to integrate advertising banners and to offer the largest possible choice to users. There are also other formats, in particular rectangles inserted onto the screen, for example in the middle of the screen.

In general, regardless of the size used, the display panel can be personalized by the user. In fact, the user can indicate his areas of interest. Advertising links are displayed in relation to these areas of interest. The display panel can also be personalized by a company wishing to carry out an advertising campaign. Functions can also be added, such as in particular a pop-up advertisement blocking tool.

When the host has defined his choice criteria or areas of interest, the display panel is downloaded by the user and the display panel is then able to display advertising links.

The above-mentioned sixth format (called FeedSpider) is illustrated in FIG. 8a. In this example, the display panel 111 includes five areas. The first area is a function control area 113, displaying the indications for the management of the panel itself and for access to particular functions. These indications can, for example, concern the movement, opening, closing, display or elimination of the panel 111. Closure of the panel 111 is understood to mean the elimination of the display of the areas forming this panel, with the exception of the function control area. Opening is understood to mean the display of all the areas 113, 114 of the display panel. Elimination corresponds to the removal of the panel 111 completely, including the function control area 113. Deployment corresponds to the visualization of at least one part of the panel 111, that is to say at least the function control area 113 and, optionally, the other areas, namely said display areas 114.

The panel 111 is made in the form of software, preferably written in a language known under the acronym dhtml (dynamic hypertext markup language), that offers flexibility adapted to these types of applications.

In FIG. 8a, the panel includes four rectangular display areas 114, arranged around the function control area 113. This control area 113 is rectangular and the display areas open in the four corners of the control area. These display areas allow different types of elements to be made visible. Among these, there are in particular advertising links, or promotional links, that is to say links that allow a netsurfer to access an advertising site from a host site. These links are represented by reference 115 in FIG. 8a. The activation and the use of such links are explained in detail below.

Preferably, at least one display area 114 is reserved for the display of advertising links, while the other areas are left at the disposal of the user. Among the types of display links there may be data without a link, for example, the address or telephone number of the owner of the host site or of the company, as represented under reference 116 in FIG. 8a. It is also possible to display photography or an access plan or any other element of this type. Clicking on this type of element has no effect.

Another type of element can include a link towards another page on the host site, as indicated by reference 117. This link can be indicated in the form of a URL address, a text and/or an image. For example, it is possible to display an image representing an access plan connected to a page of the site including the same access plan on a larger scale. It is also possible to add text or an image to a multimedia file.

Another element can include a link towards a page of another Internet site. As previously, the link can be executed in the form of a URL address, a text and/or an image. This is illustrated by reference 118.

At least one of the links can be a VoIP link, as described later with reference to FIG. 9.

In one implementation, the links are defined by the owner of the host site, using a configuration assistance menu which is found in the management site 121, by introducing first the element (text/image) that the user wishes to display in a corresponding area of the display panel, then by connecting this element to a URL address, if necessary.

In another implementation, the links are automatically generated in the following way. When the owner of a host site 112 wishes to place sponsored links 115 on his site, he defines the types of links that he wants to appear by means of keywords and/or categories. These are stored in a database 120 of a management site 121, as represented in FIG. 7. Similarly, by means of a second configuration assistance menu intended for sponsors, an advertiser who wants the links towards his site to appear on a host site defines the type of host sites on which he wishes his link to be seen by means of keywords or categories. These elements are also stored in a database 122 of the management site 121. An automatic search for links is carried out on the basis of these categories and/or these keywords, by searching for a similarity between the host sites and the advertisers, as described previously.

In this embodiment, it is possible to define a maximum number of displayed links. As an example, a maximum N can be displayed, for example ten links in an area of the panel. These N links can be the most pertinent N links, that is to say those for which the criteria defined by the host site and the advertisers sites are the most similar. It is also possible to display N links determined at random or according to a rule established among all the advertiser sites that respond to the criteria of the host site.

In another embodiment, the elements displayed in each area of the display panel are of a same type. For example, one of the areas 116 contains only data without a link. Another area 117 of the array contains only links towards other pages of the host site. A third area 118 contains only links towards the pages of other sites and the fourth area 115 contains sponsored links.

It is possible for the display of certain areas to be optional while, for others the display is obligatory. In particular, the display of an area containing sponsored links 115 would be obligatory, while the use of the other areas is left under the control of the owner of the host site.

For the implementation of this invention, one area will include a zone linked to the sponsor site enabling a user to initiate a VoIP communication with the holder of a sponsor site, as more fully described in connection with FIG. 9.

The function control area 113 can contain icons or text that render intelligible the different functions available. For example, by placing a pointer such as a computer mouse on a specific icon in the functional area, having for example the form of a hand, and by moving this pointer, it is possible to displace the display panel 111, which allows access to the entire contents of a page of the site without having to close the display panel. It is also possible to associate an action on a computer to a function of the display panel. As an example, the pressing of a function key designated by “Fct”, together with the pressing of a mouse button can create one or more actions such as opening or closing, display or elimination of the display panel 111; these actions can be different according to the present state of the panel.

This management platform 121 (FIG. 7) contains management means 124 including the data necessary for the definition of the display panel. More concretely, the management platform 121 includes, for each host site 112, formal data and basic data.

The formal data relates in particular to the size, location, colors and the form of the display panel 111. It can also relate to the number of areas displayed or any other data that allows the definition of the general aspect of the display panel 111.

The basic data relates to the data necessary for the working of the display panel 111, in particular the URL addresses of the links to appear on the panel 111. It also relates to the keywords and the criteria that have been defined by the owner of the host site and that are stored in the database 120 for the criteria of the host sites 112.

This information is contained in a computer file called a management file 125 and connected to the management centre 121. A link towards this file 125 must be placed in the computer code of the host site 112. It should be noted that this link is only formed by the file address and that no other element must be modified in the computer code of the host site 112. This means, in particular, that the computer code of the host site 112 does not contain any information relating to the aforementioned formal data, unlike the usual sites existing at present.

The display panel 111 is configured according to the requirements of the owner of the host site 112, and is configured by this owner, starting from his site, by accessing the management file 125 containing all the data required. It is to be noted that a configuration assistance menu can be provided to define not only the formal aspects of the display panel 111, but also the functional aspects. This assistance menu can, for example, propose different formats for the display panel 111 that are predefined and/or to be chosen by the user. The assistance menu also allows the introduction of keywords in free text form and/or the designation of predefined categories.

Access to the file 125 of the management platform 121 related to a determined host site 112 is carried out by providing an identification code connected to this host site 112, in such a way as to guarantee that the person trying to access this file 125 is in possession of the necessary rights. This identification can be carried out in a conventional way by the introduction of a username and a password, although other means such as, in particular, cryptographic processes can be used. When the management centre 121 has determined that a person has the necessary rights to modify the contents of the management file 125, the latter is made accessible to this person, in such a way as to authorize a certain number of modifications.

This process is particularly advantageous due to the fact that installation, configuration and modifications are extremely simple to carry out and is implemented immediately. Therefore, it is possible, for example, to test different page layouts of the display panel 111, by varying the number of areas displayed 114, their size, colors, etc., until a suitable page layout is found. Similarly, at any moment it is possible to eliminate a link or add another or to correct links that are no longer valid without having to wait for an authorization of the manager of the management sites 121. If the sponsored links 115 appearing on the host site 112 are not deemed suitable for its owner, it is also very simple to prohibit the display of a determined link by indicating its URL address in the management file 125 and by specifying that this link should not be used. It is also possible to change the keywords or the categories used that as a result will modify the links that are automatically generated.

As previously indicated, the management platform 121 contains another database 122, attached to advertisers or promoters. This database 122 contains all the data related to these advertisers, in particular the categories and/or the keywords defining their site or the host sites 112 on which they want appear. As an example, an advertiser marketing top-of-the-range cars intended for certain determined socio-professional categories could register under the keywords or categories relating to this kind of clientele, rather than in the category “Car”.

The advertiser database 122 also contains a certain number of criteria necessary for the management of the financial aspects of the links. In particular, this database 122 can contain a total amount corresponding to the maximum amount that the advertiser is prepared to invest for a given campaign, as well as an amount to be paid for access to its advertisements from a host site, called cost per click. Therefore, each time a netsurfer accesses a promoter's site through a host site, the promoter pays an amount corresponding to the cost per click, until the total amount is reached. At this moment, the advertiser will be requested to pay into his account or the link will be withdrawn from the host site 112. It should be noted that the cost per click can be defined statically or dynamically and variably according to certain parameters such as the number of genuine visits per day, etc. In practice, the cost per click can be defined according to the number of categories and/or keywords introduced by the sponsor. The higher the number of categories, the more the advertisements are targeted and the higher the cost per click will be. Other financial approaches can also be provided. For example, it is possible to define not only a cost per click but also a cost for the duration of visits to the site of the promoter, on the basis that the longer the visit to the site, the more interested the visitor will be. Of course, a combination of the two approaches is possible, by combining a flat rate through a cost per click and a variable cost according to duration.

The management platform 121 includes a financial management database 126. This base registers the host sites 112 from which the sponsor sites 123 have been visited, the sponsor sites 123 that have been visited in relation to the host site 112 that generated these visits, as well as invoicing parameters. These parameters are those previously mentioned, namely the cost per click and/or the visit duration, as well as all parameters that must be taken into account to establish a distribution of the amounts involved in these operations.

This arrangement is particularly advantageous over prior art devices, since it combines the advantages of different existing browsing systems, without presenting the drawbacks. In particular, the device does not require the introduction of the configuration parameters into the computer code of the host site, which allows simpler installation and greater flexibility in its configuration and method for use. As an auxiliary aid element to browsing it can remain available to the user either continuously or on request. The display panel 111 allows browsing between sites or within one site; it is very user-friendly and effective, without implying an important and irreversible loss of the space available to display useful data. Furthermore, it allows the management of sponsored links in a simple, flexible and targeted way both for the owner of a host site as well as for the owner of a sponsor site.

The management platform of FIG. 7 integrates into the overall system according to the invention and can include any of the features described with reference to FIGS. 1-6.

Managing VoIP and Other Communications According to the Invention

FIG. 9 is a diagram of a VoIP-based application that enables control over communications with professional partners. Using programs like SKYPE, MSN and GIZMO, pay-per-call enables an advertiser to enter into direct contact with a client without any communications expense, either for technical support, direct marketing or sales assistance.

This technology can be incorporated in the described systems for the contextual display of subjects as part of each of the sponsor/host management platform's services. This enables website editors, search engine providers and portals with vertical-hierarchy or general-purpose portals, to operate sponsored link services under their own brand, in combination with a back-office and ad-servers in ASP mode, providing also VoIP connection.

The described VoIP-based application can also be provided as part of the browsing system according to WO/2004/06156, or as a stand-alone system managed by web services or dedicated APIs.

The basic concept is that when a websurfer clicks on an advert he or she can be directly connected to the advertiser/sponsor via a VoIP application such as SKYPE. If no telephone operator who can handle the user's enquiry on a specific product or service in the user's language is available, the websurfer will be immediately redirected to a web page on which the websurfer can request a call-back.

The system constitutes a virtual call center that operates like a telephone exchange. It is connected to the communications management platforms in order to manage incoming calls as well as the activities of commercial advisors.

The communications management platform or the VoIP-based system can be arranged to direct the incoming calls as a function of various parameters such as a websurfer's language and the availability of commercial advisors who may be located in multiple geographical zones, and the commercial advisor's classified competence to deal with enquiries for a particular product or service.

The advertisers or other users can be charged per call, when a conversation exceeds a minimum duration defined by the system.

The VoIP-based system according to this invention can have the following key operating features:
Automatic Availability Management: it automatically directs calls only to available operators or commercial advisors who can predefine available time slots, or display an absent signal when they are not available for calls.
Language Management: it has a language management arrangement whereby calls can be directed as a function of the operators' language(s) according to a specified choice on the user's request.
Product Management: it also has a function for directing calls to operators as a function of particular products or services. This is particularly important for sponsors offering a wide range of products and/or services.
Quota Management: it can determine a maximum quota of calls that each operator may receive.
Record of Calls: it can store a precise record of each enquiry and each call—each advert clicked, each keyword clicked, the originating site, date and duration of the call, subject of the call, the product concerned, comments, categorization of the call (“of interest”, “not of interest”, “client”, . . . ), clients' first and second names, clients' e-mail address, etc. This call record can include the system automatically providing, when a communication is set up, an electronic data entry form for the operator to record data about the communication during and/or after the communication.
Data Export: it can allow the export of call records in CSV (Concurrent Version Systems) or XML format for exploitation by a CRM (Customer Related Management) or other business applications.
Web Back-Office Management: it can include a web back-office management unit which provides the management platform for setting up operators, and which provides parameters for the operators, manages products; provides access to the operators' activities, and provides operator performance reports.

FIG. 9 schematically shows how a client 150 (websurfer, prospective customer) accesses an advertiser 160 via a team of telephone operators, sales advisors or a customer support service 170 using the VoIP-based system of the invention, based on the use of SKYPE, as an example.

First, the client 150 clicks for example on an advert displayed on his computer screen via the Internet using a system for contextual display of adverts, preferably the previously-described system or that using the browsing device according to WO/2004/06156. This click connects to the communications management platform 30 that recovers the status of advertiser 160 on the SKYPE network, i.e. the occupancy of the team of telephone operators, sales advisors or customer support service 170. This determines the availability of the advertiser's operators to take calls, as well as their language, technical competence for different products or services, etc, and this status is displayed on the client's computer screen. The client then for example immediately makes a request to call the advertiser 160 if the advertiser's status is “available” (or the user is directed to a web-page with an indication to call later, if the status of the operator is “occupied”, in which case the call request is deferred). This call request is logged by the management platform 30 that then transmits the request to the advertiser 160 where it goes to a competent/available operator. In response to this call request, the advertiser 160's operator calls the client 150 for example using SKYPE. During and at the end of the call a log/record is made of the call, as previously described, by the communications management platform 30. The call record can be stored at the location of the advertiser 160 and/or in the management platform 30. This communications management platform 30 can also perform all of the aforementioned functions.

The inventive system and method for managing the placement of VoIP and other communications via the Internet can be summarized as follows. Clients/users 150 at numerous host sites can access sponsor's sites, for example advertisers 160. Each host site has at least one zone linked by VoIP enabling a user 150 to initiate a VoIP communication, the link alternatively serving also to initiate another communication such as video, telephone, or e-mail, with the sponsor, by clicking on an advert, for example. For this, the user 150 formulates a request that can be made at the host site using an electronic data-entry form provided by the advertiser. The request specifies the user's language (preferably selected from a predetermined list of the languages spoken by the advertiser's operators; for example this could be English, Spanish and French for the North American market, but a much wider list for international operations, depending on the sponsor's markets), the user's telephone number/address (this is typically the VoIP ID which can be the SKYPE ID, where SKYPE is used; but can include the user's regular telephone number and/or e-mail address where the user is not a registered user of SKYPE or another VoIP service) and one or more products or services of interest selected from a list provided by the advertiser. For handling the VoIP and other communications, the sponsor site has an associated call center (like a telephone exchange) with a team of operators, including sales representatives and technical advisors, represented at 170 in FIG. 9. Each operator has given language capabilities and is classified as being competent for dealing with enquiries on one or more of the products or services. The operators can be located together or at remote locations and each operator can have his/her own time schedule, and schedule for vacations etc. which is of course known to the advertiser's communications management platform 30.

The system/method according to the invention comprises for each advertiser/sponsor a management platform 30 that constitutes a virtual call center. This management platform 30 is arranged, in response to a user request, as outlined above, to initiate a communication with the sponsor, to perform the following four operations or at least (a), (b) and one of (c) and (d):
(e) It checks if any operators on the sponsor's telephone exchange 170 having the language capability (e.g. English, French or Spanish) and competence to deal with the enquiry on the given product(s) and/or service(s) specified in the request are available to make communications. In other words, if one qualified operator is occupied/unavailable, it passes to the next one and so on. If all operators are occupied or if there is no current or upcoming availability, a message can be sent to the user to call back at a later date/time.
(f) It transmits the user's request to an operator on the sponsor's call center 170 having the language capability and competence to deal with the enquiries on the product(s) and/or service(s) specified in the request and who is available to make communications immediately or has an upcoming availability to make communications. In this case, the operator, immediately, or as soon as he/she has finished a current communication, or when convenient thereafter, can initiate the VoIP or video communication or other communication (e-mail or telephone) using the user's number/address specified in the request.
(g) When the operator initiates the VoIP, video or telephone communication with the user in response to the request, the management platform 30 sets up an electronic data entry form on the operator's PC screen for the operator to record data about the communication during and/or after the communication. This form can thus be filled by the operator as a function of the interaction between the operator and the user during the 2-way communication.
(h) It logs all user requests for a call to the sponsor, and all resulting VoIP and other communications initiated by the operators, to provide a set of data on said requests and communications. This data can be presented in the form of statistics arranged as chosen by the advertiser. It may also include data input from the electronic data input form is step (c).

For the described VOIP-based call-center system combined with the contextual display of adverts, it is convenient to operate in a pay-per-click mode where the advertiser pays per click, for example limited to paying only when a telephone communication is initiated. Different invoicing modes are also possible in particular for other applications involving different relationships between two parties. Examples of other invoicing modes are: charging a license fee, charging according to the duration of the communication, or making a flat-rate charge for example according to the number of operators.

In addition to the contextual display of adverts, the described VOIP-based system applies generally to any applications involving sponsor sites that are associated with telephone operators for replying to calls initiated by clients/websurfers, including: Distance Learning; Technical Support Services; Advisory Services; E-business; and Telemarketing.

As mentioned previously, the invention provides a virtual call center that can easily be set up with no additional hardware investments or software costs because the inventive system can run on a company's existing infrastructure of computers with Internet access. All that is required is to have SKYPE or another VoIP application installed on the computer. In effect, setting up the inventive virtual call center only requires the registration of an account with an entity in charge of the system, the configuration of a few of agents/operators, and some simple links placed within the advertiser's/sponsor's website.

1. A system for managing the placement of VoIP communications and other communications, such as video, telephone and e-mail, via a distributed computer network such as the Internet wherein a plurality of host sites can access at least one sponsor site, each host site has a zone linked to the sponsor site to enable a user to initiate a VoIP communication or another communication, such as video, telephone, or e-mail, with the holder of a sponsor site (“the sponsor”) by making a request that specifies the language used, the user's VoIP ID or telephone number/e-mail address and one or more products or services of interest, and the sponsor site has an associated call center with a plurality of operators for handling the VoIP and other communications, each operator having given language capabilities and being classified as competent for dealing with enquiries on one or more products or services,
the system comprising at least one communications management platform that serves as a virtual call center and that is arranged, in response to a user request from the host site to initiate a communication with the sponsor, to perform the following operations (a), (b) and at least one of (c) and (d):
(a) to check if any operators of the call center having the language capability and competence to deal with the enquiries on the product(s) and/or service(s) specified in the request are available to make communications,
(b) to transmit the user's request to an operator of the call center having the language capability and competence to deal with the enquiries on the product(s) and/or service(s) specified in the request and who is available to make communications or has an upcoming availability to make communications,
(c) to set up, when the operator initiates a VoIP, video or telephone communication with the user in response to a request, an electronic data entry form for the operator to record data about the communication during and/or after the communication, and
(d) to log all user requests for a call to the sponsor, and all resulting VoIP or other communications initiated by the operators, to provide a set of data on said requests and communications.

2. The system of claim 1, wherein the specification of the language in the request is by selection of one of a predetermined number of language options in the request.

3. The system of claim 1, wherein the specification of the language in the request is by the context of the language of the request.

4. The system of claim 1 wherein the sponsor site provides: targeted contextual display of subjects, in particular advertising; distance learning; technical support services; advisory services; e-business; or telemarketing.

5. The system of claim 4 which is part of a greater system for the targeted contextual display of subjects, in particular advertisements, in a distributed computer network such as the Internet which comprises a plurality of sponsor sites each containing subjects to be displayed on host sites and a plurality of host sites each having at least one page arranged to display subjects from sponsor sites, wherein a page of the host sites with a zone linked to the sponsor site contains a contextual subject such as an advertisement.

6. The system of claim 5, comprising a plurality of sponsor/host management platforms each having operating means that include:
a sponsor site management unit accessible to sponsors, the sponsor site management unit comprising means for sponsors to administer the targeted display of subjects from sponsor sites, and means for storing keywords, categories and/or parameters that are derived from sponsor sites and that identify contexts for the targeted display of subjects in the host sites;
a host site management unit accessible to hosts, the host site management unit comprising means for hosts to administer the targeted display of subjects from sponsor sites on pages of their host sites, and means for storing keywords, categories and/or parameters that are derived from host sites and that identify contexts by which the host sites are targeted; and
means for matching the keywords, categories and/or parameters of the sponsor sites with those of the host sites for the targeted contextual display of subjects from sponsor sites on host sites.

7. The system of claim 6, wherein:
the system comprises a shared server platform common to the sponsor/host management platforms;
said operating means of all sponsor/host management platforms are compatible, and said means for matching of the sponsor/host management platforms are interconnected via the shared server platform;
each sponsor/host management platform is associated with its own sponsor sites and its own host sites who access only that sponsor/host management platform, each sponsor/host management platform constituting an autonomous system for the targeted contextual display of subjects in the distributed computer network; and
the shared server platform is arranged to enable the targeted contextual display of subjects from sponsor sites on host sites that are associated with different sponsor/host management platforms.

8. The system of claim 7 wherein:
each sponsor/host management platform is identified by its own management platform code that is different for the different sponsor/host management platforms;
the keywords, categories and/or parameters of each sponsor/host management platform's sponsor sites and the keywords, categories and/or parameters of each sponsor/host management platform's host sites are associated with the management platform code of the sponsor/host management platform with which they are associated;
the keywords, categories and/or parameters of sponsor sites, which are associated with the management platform code of one sponsor/host management platform, are available via the shared server platform for matching with the keywords, categories and/or parameters of the host sites of other sponsor/host management platforms, said availability being subject to possible exceptions; and
the keywords, categories and/or parameters of host sites, which are associated with the management platform code of one sponsor/host management platform, are available via the shared server platform for matching with the keywords, categories and/or parameters of the sponsor sites of other sponsor/host management platforms, said availability being subject to possible exceptions.

9. The system of claim 6 further comprising means for compiling statistics relating to the operations performed relating to given sponsor sites and to given host sites, said statistics being associated with the management platform codes of the sponsor sites and host sites.

10. The system of claim 7 wherein each sponsor/host management platform comprises means for compiling said statistics.

11. The system of claim 7 wherein the shared server platform comprises a central statistical unit that is common to the sponsor/host management platforms, the central statistical unit comprising means for compiling statistics relating to operations performed by the different sponsor/host management platforms relating to given sponsor sites and operations performed by the different sponsor/host management platforms relating to given host sites.

12. The system of claim 11 wherein said compiling means compiles statistics relating to the number of times that given sponsor sites communicate with or are displayed or accessed by host sites, the duration of such communication, display or access and/or the number of times that an action is performed in relation thereto, and to the number of times that given host sites communicate with or display or access sponsor sites, the duration of such communication, display or access and/or the number of times that an action is performed in relation thereto.

13. The system of claim 6 wherein each sponsor/host management platform comprises means for deriving said keywords, categories and/or parameters from sponsor sites and host sites, the keyword/category/parameter deriving means including at least one of the following:
e) means for assisting the input of keywords by a sponsor or host of a sponsor site or a host site;
f) means for automatically generating keywords, categories and/or parameters by analysis of text in a site;
g) means for generating keywords, categories and/or parameters from metatags in the header/title of a site; and
h) means for processing audio content of a site and for generating keywords, categories and/or parameters from the processed audio content.

14. The system of claim 6 which operates with host sites whose display panel, in addition to having a zone linked to the sponsor site to enable the user to initiate a telephone communication in particular by VoIP with a sponsor, comprises at least one of:
i) a horizontal or vertical banner or other fixed space;
ii) a sidebar;
iii) linked text that activates a display in response to a user actuation;
iv) a superimposed movable element that can be displaced on a page of the host site and that contains links that activate a display in response to a user actuation;
v) a panel common to several pages of a host site;
vi) display area(s) structured to display at least one of the following types of links: sponsored link; link towards a page on another site; link towards another page on the host site;
vii) a display panel made up of a function control area having a rectangular form, and rectangular display areas that can be opened in the corners and/or along edges of the control area; and
viii) display area(s) including images and/or text associated with sponsored links

15. The system of claim 6 wherein the sponsor/host management platforms comprise means for storing the codes that define the attributes of the display panel of host sites in the management platform, said storing means in the sponsor/host management platform being accessible from the respective host sites.

16. The system of claim 6 wherein at least one sponsor/host management platform maintains a site that is available as sponsor site.

17. The system of claim 6 wherein the shared server platform does not dispose of its own means that provide the functions of said operating means but places into communication said means for matching of the different sponsor/host management platforms.

18. A method of managing the placement of VoIP and other communications, such as video, telephone and e-mail, via a distributed computer network such as the Internet wherein a plurality of host sites can access at least one sponsor site, each host site has a zone linked to the sponsor site to enable a user to initiate a VoIP communication or another communication, such as video, telephone or e-mail, with the holder of a sponsor site (“the sponsor”) by making a request that specifies the language used, the user's VoIP ID, telephone number or e-mail address and one or more products or services of interest, and the sponsor site has an associated call center with a plurality of operators for handling the VoIP and other communications, each operator having given language capabilities and being classified as competent for dealing with enquiries on one or more products or services,
the method comprising providing at least one communications management platform that serves as a virtual call center and that, in response to a user request from the host site to initiate a communication with the sponsor, performs the following operations (a), (b) and at least one of (c) and (d):
a) checks if any operators on the sponsor's call center having the language capability and competence to deal with the enquiries on the product(s) and/or service(s) specified in the request are available to make communications,
b) transmits the user's request to an operator on the call center having the language capability and competence to deal with the enquiries on the product(s) and/or service(s) specified in the request and who is available to make communications or has an upcoming availability to make communications,
c) sets up, when the operator initiates a VoIP, video or telephone communication with the user in response to a request, an electronic data entry form for the operator to record data about the communication during and/or after the communication, and
d) logs all user requests for a call to the sponsor, and all resulting VoIP or other communications initiated by the operators, to provide a set of data on said requests and communications.

19. The method of claim 18, wherein the sponsor site provides: targeted contextual display of subjects, in particular advertising; distance learning; technical support services; advisory services; e-business; or telemarketing.
